(19) United States
(12) Patent Application Publication
(10) Pub. No.: US 2022/0176509 A1
(43) Pub. Date: Jun. 9, 2022

(54) METHOD FOR INSPECTING NORMALITY OF A SPINDLE OF A MACHINE TOOL

(71) Applicant: NATIONAL FORMOSA UNIVERSITY, Yun-Lin County (TW)

(72) Inventors: TZU-CHI CHAN, YUN-LIN COUNTY (TW); YU-CHUAN WANG, YUN-LIN COUNTY (TW)

(21) Appl. No.: 17/114,956

(22) Filed: Dec. 8, 2020

(51) Int. Cl. B23Q 17/09; B23Q 17/12; G06F 17/15

(52) U.S. Cl. CPC B23Q 17/0957; B23Q 17/0971; B23Q 2717/00; G06F 17/156; B23Q 17/12

(57) ABSTRACT

A method for inspecting normality of a spindle of a machine tool is provided. Spectral analysis, time domain analysis and principal components analysis are performed on a vibration signal that results from the vibration of the spindle, so as to build a Gaussian mixture model. Then, based on a difference between the Gaussian mixture model and a predetermined reference model, whether the machine tool is operating normally can be determined in real time.

### FIELD

The disclosure relates to an inspection method, and more particularly to a method for inspecting a spindle of a machine tool.

### BACKGROUND

High speed and high precision have become the trend of machine tool development. Failure to detect the abnormal condition of a spindle of a machine tool during the machining process will affect the production yield and the service life of the spindle.

However, conventional methods for inspecting the spindle of the machine tool cannot find out whether the spindle is working properly or not in real time during the machining process. In general, inspection, measurement and calibration of the spindle is performed either before or after the machining process, but frequent stoppages for these operations may result in increased processing time and production costs.

### SUMMARY

Therefore, an object of the disclosure is to provide an inspecting method that can inspect normality of a spindle of a machine tool in real time when the machining process is ongoing.

According to the disclosure, the method is implemented by a computer device, and includes: A) receiving a vibration signal generated by a vibration sensor that senses vibration of the spindle during an operation period in which the spindle is in operation, the vibration signal including a plurality of vibration magnitude values that respectively correspond to multiple time points in the operation period; B) performing spectral analysis on the vibration signal to obtain a plurality of frequency-domain eigenvalues; C) performing time domain analysis on the vibration signal to obtain a plurality of time-domain eigenvalues; D) performing principal components analysis on the frequency-domain eigenvalues and the time-domain eigenvalues to obtain a plurality of analysis data pieces that respectively correspond to multiple principal components obtained from the principal components analysis, each of the analysis data pieces including a plurality of analysis eigenvalues; E) for each of the analysis data pieces, building a Gaussian model based on the analysis eigenvalues of the analysis data piece; F) building a Gaussian mixture model based on the Gaussian models built respectively for the analysis data pieces; G) acquiring a difference between the Gaussian mixture model and a predetermined reference model; and H) generating an inspection result that indicates whether the machine tool is operating normally based on the difference and a predetermined threshold.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating an embodiment of an inspecting method according to the disclosure;

FIG. 2 is a flow chart illustrating steps of the embodiment;

FIG. 3 is a flow chart illustrating sub-steps of step 22 of the embodiment;

FIG. 4 is a plot exemplarily illustrating a result of principal components analysis; and

FIG. 5 is a flow chart illustrating sub-steps of step 29 of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

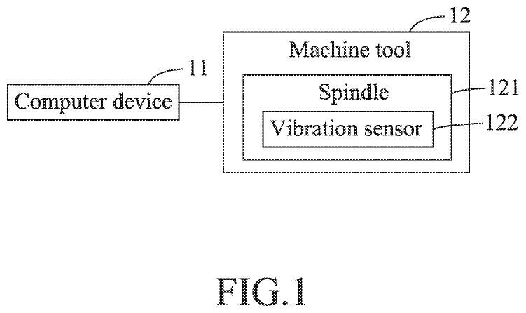

FIG. 1 exemplifies a computer device 11 and a machine tool 12 that is to be inspected, and reference to FIG. 1 will be made when describing an embodiment of an inspecting method according to this disclosure. The machine tool 12 includes a spindle 121 that is provided with a vibration sensor 122 for sensing vibration of the spindle 121, where the vibration sensor 122 is electrically connected to the computer device 11. In this embodiment, the spindle 121 may include, for example, two cutters (not shown), and the vibration sensor 122 may be realized as, for example, an accelerometer, but this disclosure is not limited in this respect.

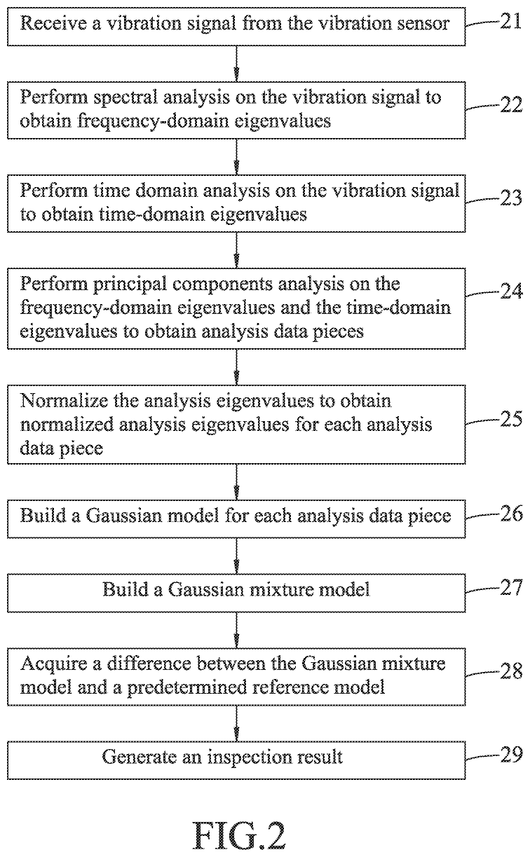

Further referring to FIG. 2, the embodiment of the inspecting method for inspecting normality of the spindle 121 according to this disclosure includes steps 21-29.

In step 21, the computer device 11 receives a vibration signal generated by the vibration sensor 122 that senses vibration of the spindle 121 during an operation period in which the spindle 121 is in operation. The vibration signal includes a plurality of vibration magnitude values that respectively correspond to multiple time points in the operation period. In this embodiment, the operation period may be of, for example, 100 seconds, but this disclosure is not limited to such.

In step 22, the computer device 11 performs spectral analysis on the vibration signal to obtain a plurality of frequency-domain eigenvalues.

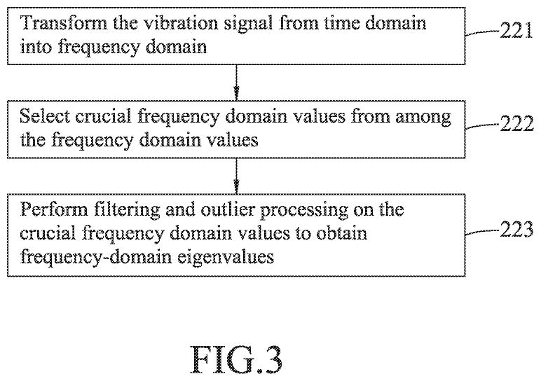

Step 22 includes sub-steps 221-223, as shown in FIG. 3.

In sub-step 221, the computer device 11 transforms the vibration signal from time domain into frequency domain to obtain a plurality of frequency-domain values using, for example, Fourier transform, but this disclosure is not limited in this respect.

In sub-step 222, the computer device 11 selects a plurality of crucial frequency domain values from among the frequency domain values. In this embodiment, the computer device 11 calculates a main frequency of the vibration signal, and makes those of the frequency domain values that respectively correspond to first to thirtieth multiples of the main frequency serve as the crucial frequency domain values. For example, the main frequency may be a frequency obtained by multiplying a rotational speed of the spindle 121 with the number of the cutters. In a case that the rotational speed of the spindle 121 is 8000 revolutions per minute (RPM) and the number of the cutters is two, the main frequency is 8000/60×2=266.7 Hz. However, this disclosure is not limited in this respect.

In sub-step 223, the computer device 11 performs filtering and outlier processing on the crucial frequency domain values to obtain the frequency-domain eigenvalues. In this embodiment, the computer device 11 uses the Kalman filter to filter out noise and uses a z-score filter to filter out the outliers of the crucial frequency domain values, but this disclosure is not limited in this respect.

Referring to FIGS. 1 and 2 again, in step 23, the computer device 11 performs time domain analysis on the vibration signal to obtain a plurality of time-domain eigenvalues. In this embodiment, the time-domain eigenvalues may include at least two of a kurtosis value, a root-mean-square (RMS) value, a crest factor value, a skewness value, a standard deviation value or a variance value of the vibration magnitude values of the vibration signal, but this disclosure is not limited in this respect.

The kurtosis value (K) of the vibration magnitude values can be calculated according to:

$$K = \frac{\frac{1}{n} {\sum }_{i = 1}^{n} {( {x}_{i} - \overline{x} )}^{4}}{{( \frac{1}{n} {\sum }_{i = 1}^{n} {( {x}_{i} - x )}^{2} )}^{2}} - 3$$

where n represents a number of the vibration magnitude values, xᵢ represents an i^{th} one of the vibration magnitude values, and x̅ represents an average of the vibration magnitude values.

The RMS value (M) of the vibration magnitude values can be calculated according to:

$$M = \frac{\sqrt{{\sum }_{i = 1}^{n} {x}_{i}^{2}}}{n}$$

where n represents a number of the vibration magnitude values, and xᵢ represents an i^{th} one of the vibration magnitude values.

The crest factor value (C) of the vibration magnitude values can be calculated according to:

$$C = \frac{\vert {x}_{peak} \vert}{{x}_{rms}}$$

where |xₚₑₐₖ| represents a maximum value of absolute values of the vibration magnitude values, and xᵣₘₛ represents the RMS value of the vibration magnitude values.

The skewness value (S) of the vibration magnitude values can be calculated according to:

$$S = \frac{\frac{1}{n} {\sum }_{i = 1}^{n} {( {x}_{i} - \overline{x} )}^{3}}{{( \frac{1}{n} {\sum }_{i = 1}^{n} {( {x}_{i} - x )}^{2} )}^{2 / 3}}$$

where n represents a number of the vibration magnitude values, xᵢ represents an it: one of the vibration magnitude values, and x̅ represents an average of the vibration magnitude values.

The standard deviation value (σ) of the vibration magnitude values can be calculated according to:

$$σ = \sqrt{\frac{1}{n} {\sum }_{i = 1}^{n} {( {x}_{i} - \overline{x} )}^{2}}$$

where n represents a number of the vibration magnitude values, xᵢ represents an i^{th} one of the vibration magnitude values, and x̅ represents an average of the vibration magnitude values.

The variance value of the vibration magnitude values is the square of the standard deviation value of the vibration magnitude values.

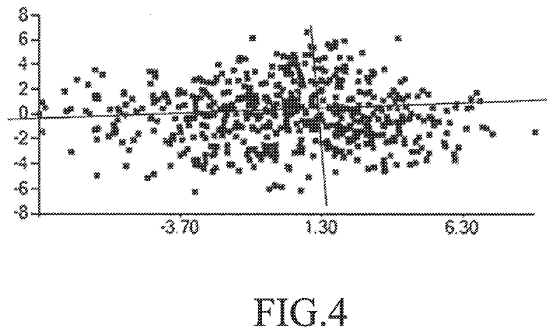

In step 24, the computer device 11 performs principal components analysis on the frequency-domain eigenvalues and the time-domain eigenvalues to obtain a plurality of analysis data pieces that respectively correspond to multiple principal components obtained from the principal components analysis, where each of the analysis data pieces includes a plurality of analysis eigenvalues. In this embodiment, this step can be performed using commercially available software of, for example, xxxxx, but this disclosure is not limited in this respect. FIG. 4 exemplarily shows a distribution of a plurality of data points each representing one of the frequency-domain eigenvalues and the time-domain eigenvalues. The two straight lines in FIG. 4 represent two of the principal components obtained using the principal components analysis. Those of the data points that are crossed by a straight line serve as the analysis eigenvalues of one of the analysis data pieces that corresponds to a principal component represented by the straight line.

In step 25, for each of the analysis data pieces, the computer device 11 normalizes the analysis eigenvalues to obtain a plurality of normalized analysis eigenvalues. Normalization of an i^{th} one of the analysis eigenvalues can be performed according to:

$${y}_{norm} = \frac{{y}_{i} - {y}_{min}}{{y}_{max} - {y}_{min}} ∈ [ 0 , 1 ]$$

where yᵢ represents the i^{th} one of the analysis eigenvalues, yₘᵢₙ represents the smallest one of the analysis eigenvalues, and yₘₐₓ represents the greatest one of the analysis eigenvalues.

In step 26, for each of the analysis data pieces, the computer device 11 builds a Gaussian model based on the normalized analysis eigenvalues obtained for the analysis data piece. In this embodiment, for each of the analysis data pieces, the computer device 11 builds a Gaussian model based on an average and a variance of the normalized analysis eigenvalues obtained for the analysis data piece.

In step 27, the computer device 11 builds a Gaussian mixture model based on the Gaussian models built respectively for the analysis data pieces. A probability density function of the Gaussian mixture model can be represented by:

$$p ( x ) = {\sum }_{i = 1}^{k} {α}_{i} {g}_{i} ( x ; {μ}_{i} , {σ}_{i}^{2} )$$

where:

$${\sum }_{i = 1}^{k} {α}_{i} = 1 ;$$

$${g}_{i} ( x ; {μ}_{i} , {\sum }_{i} ) \frac{1}{{( 2 π )}^{1 / 2} {σ}_{i}} {e}^{{D}_{i}} ;$$

$${D}_{i} = - \frac{1}{2 {σ}_{i}^{2}} {( x - {μ}_{i} )}^{T} ( x - {μ}_{i} ) ;$$

k represents a number of the Gaussian models obtained in step 26;

αᵢ represents a mixture weight;

gᵢ(x;μᵢ,Σᵢ) represents an iₜₕ one of the Gaussian models;

μᵢ represents a center of the i^{th} one of the Gaussian models, namely, the average of the normalized analysis eigenvalues of the i^{th} one of the analysis data pieces that corresponds to the it: one of the Gaussian models; and

σᵢ² represents a variance of the it, one of the Gaussian models, namely, the variance of the normalized analysis eigenvalues of the i^{th} one of the analysis data pieces.

In step 28, the computer device 11 acquires a difference between the Gaussian mixture model and a predetermined reference model. In this embodiment, the predetermined reference model is a Gaussian mixture model obtained by performing steps 21 through 27 using a reference machine tool that is deemed normal during operation, and is stored in the computer device 11 in advance to performing the embodiment on the machine tool 12. In this embodiment, the difference between the Gaussian mixture model and the predetermined reference model is a non-overlap rate between the Gaussian mixture model and the predetermined reference model (i.e., equaling 1 minus overlap_rate). Since the method of obtaining the overlap rate between the Gaussian mixture model and the predetermined reference model is familiar to one having ordinary skill in the art, for example, as introduced in an article by Haojun Sun & Shengrui Wang, entitled “Measuring the component overlapping in the Gaussian mixture model” and published in Computer Science Data Mining and Knowledge Discovery, 2011, details thereof are omitted herein for the sake of brevity. In other embodiments, the difference may be a “distance” between the Gaussian mixture model and the predetermined reference model. However, this disclosure is not limited in the way to acquire the difference.

In step 29, the computer device 11 generates an inspection result that indicates whether the machine tool 12 is operating normally based on the difference and a predetermined threshold. The predetermined threshold may be stored in the computer device 11 in advance to performing the embodiment on the machine tool 12.

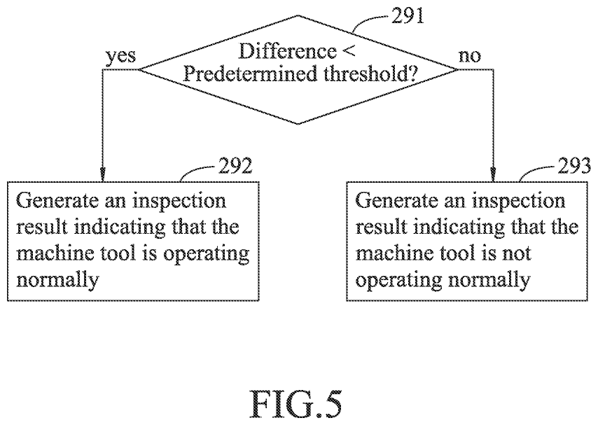

Referring to FIG. 5, step 29 includes sub-steps 291-293.

In sub-step 291, the computer device 11 determines whether the difference is smaller than the predetermined threshold. The flow goes to sub-step 292 when affirmative, and goes to sub-step 293 when otherwise.

In sub-step 292, the computer device 11 generates an inspection result indicating that the machine tool 12 is operating normally.

In sub-step 293, the computer device 11 generates an inspection result indicating that the machine tool 12 is not operating normally.

When the machine tool 12 is determined as not operating normally in step 29, the operator of the machine tool 12 may take necessary actions with respect to the machine tool 12, such as stopping operation of and then calibrating the machine tool 12, so as to minimize adverse effects (e.g., a low yield rate) resulting from the abnormal operation.

In summary, the embodiment of the method for inspecting normality of the spindle 121 of the machine tool 12 according to this disclosure uses a computer device 11 to perform spectral analysis, time domain analysis and principal components analysis on the vibration signal that results from the vibration of the spindle 121, so as to build a Gaussian mixture model. Then, based on the difference between the Gaussian mixture model and the predetermined reference model, the computer device 11 that implements the embodiment can determine whether the machine tool 12 is operating normally in real time.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for inspecting normality of a spindle of a machine tool, the method to be implemented by a computer device, the machine tool including the spindle and a vibration sensor to sense vibration of the spindle, said method comprising steps of:
A) receiving a vibration signal generated by the vibration sensor that senses vibration of the spindle during an operation period in which the spindle is in operation, the vibration signal including a plurality of vibration magnitude values that respectively correspond to multiple time points in the operation period;
B) performing spectral analysis on the vibration signal to obtain a plurality of frequency-domain eigenvalues;
C) performing time domain analysis on the vibration signal to obtain a plurality of time-domain eigenvalues;
D) performing principal components analysis on the frequency-domain eigenvalues and the time-domain eigenvalues to obtain a plurality of analysis data pieces that respectively correspond to multiple principal components obtained from the principal components analysis, each of the analysis data pieces including a plurality of analysis eigenvalues;
E) for each of the analysis data pieces, building a Gaussian model based on the analysis eigenvalues of the analysis data piece;
F) building a Gaussian mixture model based on the Gaussian models built respectively for the analysis data pieces;
G) acquiring a difference between the Gaussian mixture model and a predetermined reference model; and
H) generating an inspection result that indicates whether the machine tool operates normally based on the difference and a predetermined threshold.

2. The method of claim 1, wherein step B) includes:
B-1) transforming the vibration signal from time domain into frequency domain to obtain a plurality of frequency domain values;
B-2) selecting a plurality of crucial frequency domain values from among the frequency domain values; and
B-3) performing filtering and outlier processing on the crucial frequency domain values to obtain the frequency-domain eigenvalues.

3. The method of claim 1, wherein the time-domain eigenvalues include at least two of a kurtosis value, a crest factor value, a skewness value, a root-mean-square value, a variance value or a standard deviation value of the vibration magnitude values.

4. The method of claim 1, wherein step E) includes:
E-1) for each of the analysis data pieces, normalizing the analysis eigenvalues to obtain a plurality of normalized analysis eigenvalues; and
E-2) for each of the analysis data pieces, building the Gaussian model based on the normalized analysis eigenvalues obtained for the analysis data piece.

5. The method of claim 1, wherein step H) includes:
H-1) determining whether the difference is smaller than the predetermined threshold;
H-2) generating the inspection result to indicate that the machine tool is operating normally upon determining that the difference is smaller than the predetermined threshold; and
H-3) generating the inspection result to indicate that the machine tool is not operating normally upon determining that the difference is not smaller than the predetermined threshold.
